(19) United States
(12) Patent Application Publication
(10) Pub. No.: US 2008/0012828 A1
(43) Pub. Date: Jan. 17, 2008

(54) Multi-dimensional input device

(75) Inventor: Taizo Yasutake, Cupertino, CA (US)

Correspondence Address: TECHNOLOGY & INTELLECTUAL PROPERTY;STRATEGIES GROUP PC (dba TIPS GROUP), P. O. BOX 1639, LOS ALTOS, CA, 94023-1639, US

(73) Assignee: Sandio Technology Corp., San Jose, CA (US)

(21) Appl. No.: 11/827,658

(22) Filed: Jul. 11, 2007

Related U.S. Application Data
(63) Continuation-in-part of application No. 11/323,574, filed on Dec. 29, 2005.
(60) Provisional application No. 60/679,557, filed on May 9, 2005.
(60) Provisional application No. 60/680,910, filed on May 13, 2005.

(51) Int. Cl. G06F 3/033

(52) U.S. Cl. 345/163; 345/157; 345/167

(57) ABSTRACT

A method, system and apparatus for a pointing device with multiple degrees of freedom in various embodiments is provided. In an embodiment, a pointing device is provided. The pointing device includes a chassis and at least one center push button mounted on the chassis. The pointing device further includes a communications interface for coupling with a system. The pointing device also includes a signal interface between the first center push button and the communications interface, the signal interface carrying signals from the first center push button to the communications interface.

### CROSS-REFERENCE TO RELATED APPLICATIONS

This application is a continuation-in-part of U.S. patent application Ser. No. 11/323,574, entitled “Multi-Dimensional Input Device” and filed on May 9, 2006, which is hereby incorporated herein by reference. This application is also related to U.S. Provisional Patent Applications Nos. 60/679,557, filed on May 9, 2005, and 60/680,910, filed on May 13, 2005, both of which are incorporated herein by reference

### BACKGROUND

Three dimensional (“3D”) input devices are currently used in high end 3D computer-aided design (“CAD”) and 3D rendering software markets. Such 3D input devices, such as a keyboard, do not provide “mouse grade,” high precision two dimensional (“2D”) cursor movement, and therefore typically require supplemental input peripherals. A user typically will use his right hand to operate the 2D mouse and will utilize a 3D input device on the left side of keyboard using his left hand. As a result, a user is required to use both hands to do 3D graphic work.

In the past, several attempts have been made to facilitate manipulation of 3D applications. For example, a six degrees of freedom joystick was described at one point. However, the joystick requires a standard mouse for conventional 2D cursor control. Additionally, an input device with 2D mouse function and four degrees of freedom input control has also been described in the past. However, the input device is not well accepted by end users due to ergonomic issues. A charge coupled device (“CCD”) that provides six degrees of freedom input control has also been previously described. However, the device has operational ergonomic difficulties.

Another approach to add functionality to the standard mouse is to incorporate a trackball into the mouse body. However, this type of mouse cannot provide coarse or fast velocity 3D command control typically required for fly-through movement in virtual 3D environments. Other commonly used input devices include game pads and joysticks. However, game pads and joysticks typically utilize a game specific design and do not provide mouse cursor functions. As a result, game pad and joysticks are not suitable for conventional business software.

Requirements for a 3D input device vary significantly and depend on a 3D application's contents. For example, 3D CAD users typically require high precision 3D command control meaning the control speed for 3D manipulation is slower (except for a “quickview” action on 3D objects). On the other hand, 3D business software, such as a virtual model house or a virtual 3D geological map, typically require fly-through or walk-through based 3D commands. For these kinds of applications, fast velocity commands in six degrees of freedom are required to quickly move in the virtual 3D environment. In case of 3D PC games, fast commands in six degrees of freedom can be required for walk-through situations, as well as high precision/slow 3D controls such as yaw or pitch, for target shooting.

Thus, it would potentially be useful to provide a multidimensional device that facilitates manipulation of 3D applications in a convenient and efficient manner. Further, it may be useful to provide a device that provides conventional 2D input commands as well as commands in six degrees of freedom. Moreover, it may be useful to provide a system that conveniently and efficiently interfaces with a multidimensional device.

The foregoing examples of the related art and limitations related therewith are intended to be illustrative and do not provide an exhaustive review of the prior art. Other limitations of the related art will become apparent to those of skill in the art upon a reading of the specification and a study of the drawings in comparison with such prior art.

### SUMMARY

A method, system and apparatus for a pointing device with multiple degrees of freedom in various embodiments is provided. The embodiments described herein provide examples of embodiments of the invention. Thus, the embodiments should be understood as providing illustrations of the invention rather than limitations on the invention.

In an embodiment, a pointing device is provided. The pointing device includes a chassis and at least one center push button mounted on the chassis. The pointing device further includes a communications interface for coupling with a system. The pointing device also includes a signal interface between the first center push button and the communications interface, the signal interface carrying signals from the first center push button to the communications interface.

In another embodiment, a pointing device is provided. The pointing device includes a chassis. The pointing device further includes a motion tracking mechanism mounted in the chassis. The pointing device also includes a communications interface for coupling with a system. The pointing device includes a signal interface between the motion tracking mechanism and the communications interface. The signal interface carries signals from the motion tracking mechanism to the communications interface. The pointing device consists of a single center push button. The center push button is coupled to the signal interface and mounted on the chassis.

In yet another embodiment, a system is provided. The system includes a host computer. The system further includes an operating system executed by the host computer. The system also includes a device driver included in the operating system. The system includes a keyboard emulation module included in the device driver. The system further includes a pointing device coupled to the host computer. The pointing device has at least one center push button. The pointing device communicates with the device driver and provides signals from the at least one center push button to the device driver. The keyboard emulation module of the device driver is to provide keyboard command outputs corresponding to the signals from the at least one center push button.

In still another embodiment, a pointing device is provided. The pointing device includes a chassis and a motion tracking mechanism mounted in the chassis. The pointing device also includes a communications interface for coupling with a system. The pointing device further includes a signal interface between the motion tracking mechanism and the communications interface. The signal interface carries signals from the motion tracking mechanism to the communications interface. The pointing device consists of at least one center push button. The at least one center push button is coupled to the signal interface and mounted on the chassis.

### BRIEF DESCRIPTION OF THE DRAWINGS

The accompanying illustrations provide illustrations of various embodiments of the invention, and should be understood as providing examples of the invention, rather than limiting the invention.

FIG. 1 illustrates an embodiment of a pointing device with additional degrees of freedom.

FIG. 2 illustrates another embodiment of a pointing device with additional degrees of freedom.

FIG. 3 illustrates yet another embodiment of a pointing device with additional degrees of freedom.

FIG. 4 illustrates an alternate embodiment of a pointing device with additional degrees of freedom.

FIG. 5 illustrates another alternate embodiment of a pointing device with additional degrees of freedom.

FIG. 6 illustrates still another alternate embodiment of a pointing device with additional degrees of freedom.

FIG. 7 illustrates an embodiment of a switch which may be used with pointing devices.

FIG. 8 illustrates another alternate embodiment of a pointing device with additional degrees of freedom.

FIG. 9 illustrates yet another alternate embodiment of a pointing device with additional degrees of freedom.

FIG. 10 illustrates still another alternate embodiment of a pointing device with additional degrees of freedom.

FIG. 11 illustrates operation of an embodiment of a pointing device with additional degrees of freedom.

FIG. 12 also illustrates operation of an embodiment of a pointing device with additional degrees of freedom.

FIG. 13 further illustrates operation of an embodiment of a pointing device with additional degrees of freedom.

FIG. 14 also illustrates operation of an embodiment of a pointing device with additional degrees of freedom.

FIG. 15 illustrates a device which may be controlled with an embodiment of a pointing device with additional degrees of freedom.

FIGS. 16 and 17 further illustrate the device if FIG. 15.

FIG. 17A illustrates another embodiment of a system including a pointing device.

FIG. 17B illustrates a system wherein operation of a pointing device emulates operation of controls on a keyboard for a 3D application.

FIG. 17C illustrates a system wherein operation of a pointing device emulates operation of controls on a keyboard for a 2D application.

FIG. 18 illustrates a system which may work with an embodiment of a pointing device with additional degrees of freedom.

FIG. 19 illustrates another system which may work with an embodiment of a pointing device with additional degrees of freedom.

FIG. 20 illustrates still another system which may work with an embodiment of a pointing device with additional degrees of freedom.

### DETAILED DESCRIPTION

A method, system and apparatus for a pointing device with multiple degrees of freedom in various embodiments is provided. The embodiments described herein provide examples of embodiments of the invention. Thus, the embodiments should be understood as providing illustrations of the invention rather than limitations on the invention.

A pointing device allowing for control of multiple degrees of freedom is provided. The pointing device may use center push buttons to amplify the number of control modes available, and thereby to increase the degrees of freedom which may be controlled. The pointing device may further be used with a variety of systems and applications to enhance user control.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

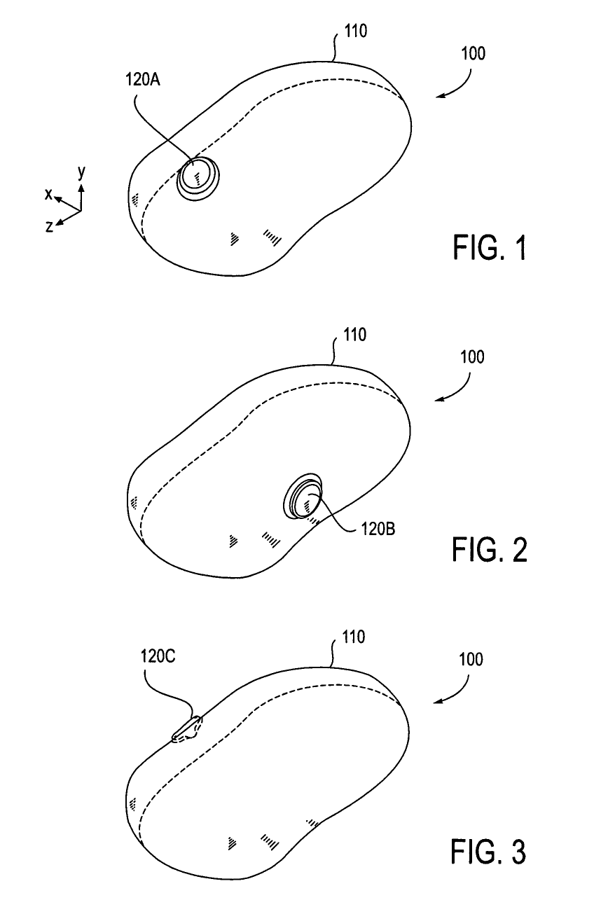

A multi-dimensional pointing device may be provided in a variety of embodiments. FIG. 1 illustrates an embodiment of a pointing device with additional degrees of freedom. Device 100 includes a chassis 110 with a button 120A mounted on top. Button 120A may be used to change the dimension in which device 100 operates. For example, button 120A may be used to cause device 100, and chassis 110 to control rotation about an axis, rather than travel along an axis. Alternatively, button 120A may also be used to operate in a different dimension, or along a different axis or type of motion from the motion otherwise handled by device 100. For example, button 120A may be used to cause rotation about an axis whereas mouse chassis is used to cause travel along an axis.

FIG. 2 illustrates another embodiment of a pointing device with additional degrees of freedom. In this instance, device 100 is provided with a button 120B mounted on the left side of chassis 110. FIG. 3 illustrates yet another embodiment of a pointing device with additional degrees of freedom. In this embodiment, device 100 is provided with a button 120C which is mounted on the right side of chassis 110. One may expect that buttons 120B and 120C have the same or similar functionality and structure as button 120A.

In one embodiment, button 120A can be used to implement an X translation command, a Z translation command, a pitch command (rotate about the X axis) or a roll command (rotate about the Z axis). Similarly, button 120B in another embodiment may be used to implement a Y translation command, a Z translation command, a yaw command (rotate about the Y axis) or a roll command. Likewise, button 120C may be used in yet another embodiment to implement a Y translation command, a Z translation command, a yaw command or a roll command. These more limited subsets of full six degrees of freedom (6DOF) can be useful in some applications. Additionally, buttons 120 may be implemented with various different structures, such as traditional switches with four points of contact used in joysticks, for example.

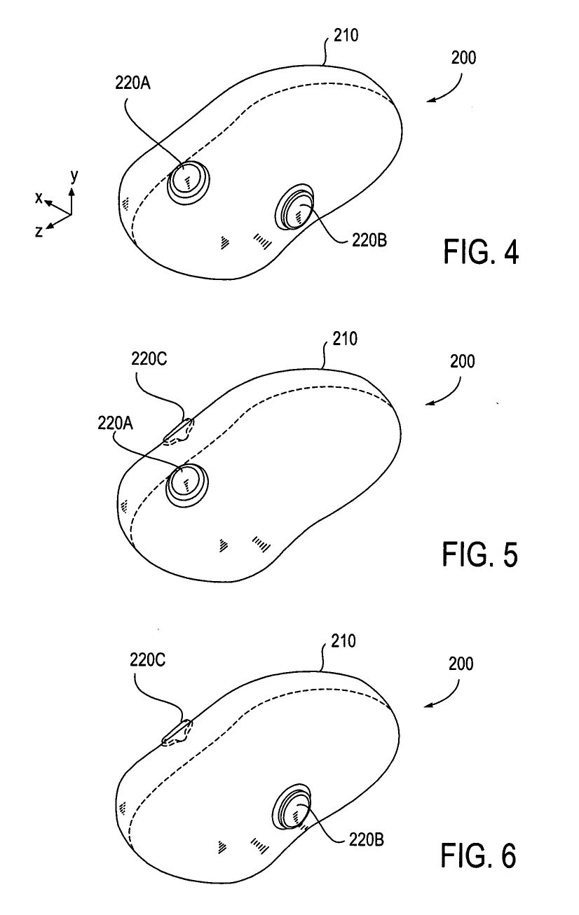

While a single button may be used to implement various functionality, one may use two buttons in other embodiments. FIG. 4 illustrates an alternate embodiment of a pointing device with additional degrees of freedom. Device 200 includes a chassis 210 with a button 220A mounted on top and a button 220B mounted on the left side. In one embodiment, button 220A can be used to implement an X translation command, a Z translation command, a pitch command or a roll command. Button 220B may be used to implement a Y translation command, a Z translation command, a yaw command, or a roll command.

FIG. 5 illustrates another alternate embodiment of a pointing device with additional degrees of freedom. Rather than providing a button 220B, a button 220C is mounted on the right side of chassis 210. Button 220C may be used in another embodiment to implement a Y translation command, a Z translation command, a yaw command or a roll command. FIG. 6 illustrates still another alternate embodiment of a pointing device with additional degrees of freedom. Buttons 220A and 220C are mounted on the left and right sides (respectively) of chassis 210. Buttons 220 may thus be implemented with switches with four points of contact, for example.

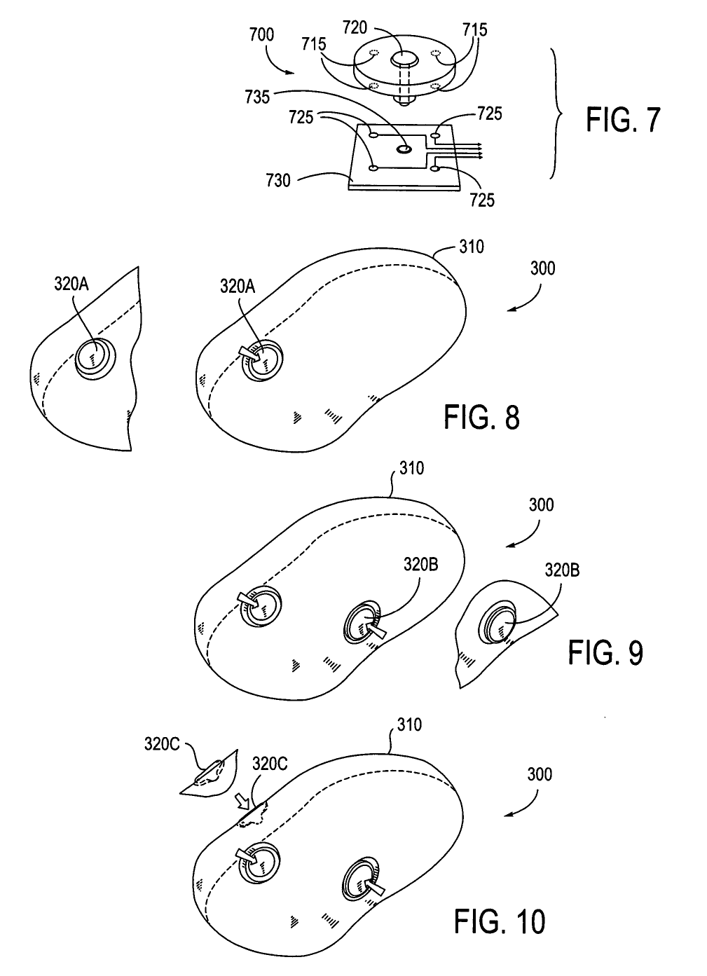

Other switches may be useful in implementing a pointing device with multiple dimensions or additional degrees of freedom. FIG. 7 illustrates an embodiment of a switch which may be used with pointing devices. Switch 720 is a center push switch. It includes a top structure 710, with four contacts 715 at cardinal points and a fifth contact extending downward from the structure 710. A substrate (PCB 730) is provided with four contacts 725 at cardinal points and a center contact 735 below the structure 710. Digital signals 740 may be transmitted to and from the switch 700. Switch 700 allows one to indicate four different signals through the contacts 715 and 725, and also allows for indication of a fifth signal through the center contact 735. This switch may be implemented through use of various commercially available products, such as switches in the ALPS-SKQU series available from Alps Electronics Ltd., Japan. However, one can also use an analog sensor such as a touch pad in a similar fashion, using a tap on the touch pad as a distinctive fifth signal, separate from translation signals.

The fifth signal provided allows one to change functionality of a switch, or to change context in which a switch operates, for example. This, in turn, allows one to change from roll to pitch to yaw, for example. Similarly, this allows one to change translation signals of a pointing device from translation (motion along an axis) into rotation (rotation about an axis) as a result of a context change for the device.

One may thus use the center push buttons on various devices. FIG. 8 illustrates another alternate embodiment of a pointing device with additional degrees of freedom. Device 300 includes a chassis 310 and a single top-mounted center push button 310A. FIG. 9 illustrates yet another alternate embodiment of a pointing device with additional degrees of freedom. The embodiment of FIG. 9 illustrates a pointing device 300 with a chassis 310, a top-mounted center push button 310A and a center push button 320B mounted on the left side of chassis 310. FIG. 10 illustrates still another alternate embodiment of a pointing device with additional degrees of freedom. The embodiment of FIG. 10 extends the pointing device 300 with a third center push button 320C which is mounted on the right side of the chassis 310.

One can use the center push button in various ways, either with a single center push button or with multiple center push buttons. With a single center push button, two sets of two degree of freedom 3D commands may be generated at any time, with the center push button used to toggle between the two modes. Thus, one may use the button to implement translation commands along two axes, then use the center push fifth signal to switch to implementing rotation commands about two axes. As an example, in one embodiment of the device of FIG. 8, the center push button may be used to implement translation along the X or Z axes in one mode, and pitch or roll rotation commands in a second mode, with the center push signal used to toggle between the two modes. The following table can be used to show control of the mode with the center push signal:

TABLE 1

Control Mode

| | 1 (Default) | 2 |
|---|---|---|
| Center Push signal | Off | On |

With two center push buttons, additional functionality can be provided. Table 2 illustrates a truth table for controlling modes with two center push buttons.

TABLE 2

Control Mode

| | 1 (Default) | 2 | 3 | 4 |
|---|---|---|---|---|
| Center Push signal | Off | On | Off | On |
| (button 1) | | | | |
| Center Push signal | Off | Off | On | On |
| (button 2) | | | | |

With four sets of control modes, one can switch between four different, and distinct, types of controls. Thus, the first control mode may involve the top button providing X or Z translation and the left button providing Y or Z translation. The second control mode (with the top center push button pressed) may involve pitch or roll commands for the top button and yaw or roll commands for the left button. With the left center push button pressed, or with both center push buttons pressed, the pointing device can be used to generate commands using the same raw data in other modes, representing a third and fourth mode respectively. Moreover, with such a configuration, one can expand the embodiments of FIGS. 4-6 from a 4DOF model to a 16DOF model, using the center push buttons.

As one may expect, this allows for further expansion when three center push buttons are used. Table 3 provides a truth table for such a configuration.

TABLE 3

| | Control Mode | | | | | | | |
|---|---|---|---|---|---|---|---|---|
| | 1 (dflt) | 2 | 3 | 4 | 5 | 6 | 7 | 8 |
| Center push | Off | On | Off | On | Off | On | Off | On |
| (button 1) | | | | | | | | |
| Center push | Off | Off | On | On | Off | Off | On | On |
| (button 2) | | | | | | | | |
| Center push | Off | Off | Off | Off | On | On | On | On |
| (button 3) | | | | | | | | |

As can be seen, the number of control modes can be controlled as if by a binary number—each additional center push button allows for a doubling of the number of modes. Additionally, one can layer these modes on degrees of freedom previously provided through the rest of the button (the four contacts at the cardinal points), such that one may expand the 6DOF capabilities of three buttons to 48DOF.

One may use these capabilities in a variety of applications. For example, one may control video games with various different degrees of freedom, using such capabilities. A center push signal may be used as a toggle switch for a 3D command mode related to velocity—a user may toggle between fast and slow modes with a single center push button, may use multiple buttons to toggle through several modes (e.g. slow, regular, fast), or may use multiple pushes of a center push button to ramp up or down a scale of speeds (e.g. ascending from slow to regular/medium to fast).

Similarly, a center push button may be used as a toggle for cruise control. Pushing the center push button (or pushing and holding) may be used to set a speed or activate a cruise control function. Thus, a subject in a video game may continuously drive, fly or run at a set speed, for example.

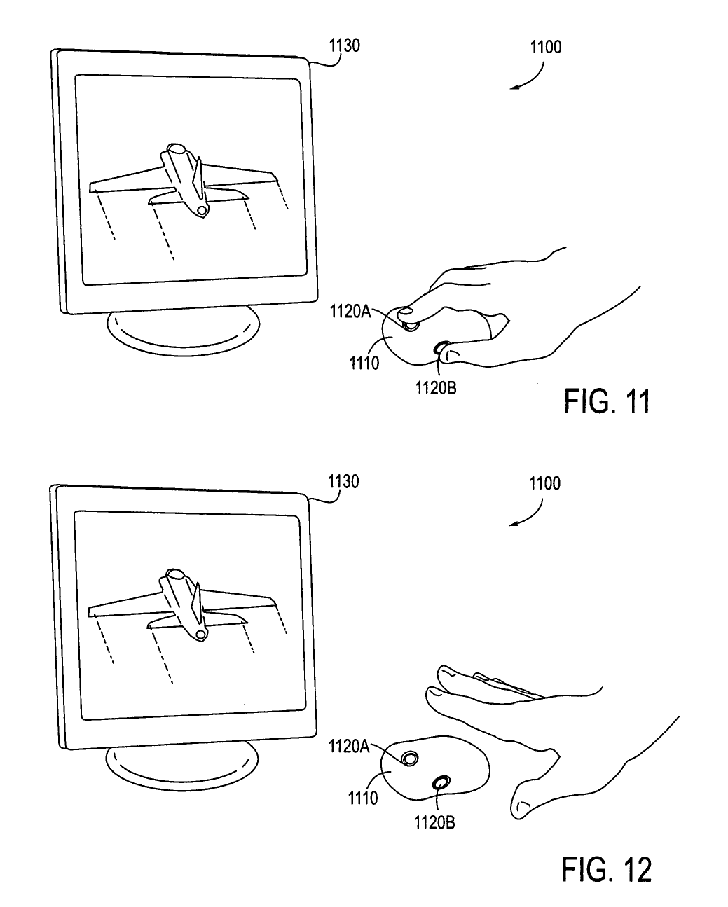

One example of use of mode control is illustrated in FIGS. 11 and 12. FIG. 11 illustrates operation of an embodiment of a pointing device with additional degrees of freedom. System 1100 includes monitor 1130, pointing device chassis 1110, and center push buttons 1120A and 1120B. Manipulation of the chassis 1110 and center push buttons 1120A and 1120B in a first mode cause a reaction on monitor 1130 (in this case manipulation of an airplane image) in a first mode. FIG. 12 also illustrates operation of an embodiment of a pointing device with additional degrees of freedom. As shown in FIG. 12, a second mode is entered. In this case, the plane continues to move forward even though the hand is not engaged with the pointing device, as a cruise control or trim mode has been entered.

One may also use other modes in the video game area of technology. For example, one may start operation in a video game in a “walk” mode. Signals from the pointing device would cause an image to walk forward, to the sides, backward, etc. A center push signal may then transition to a “run” mode. A further center push signal may then transition to a “fly” mode. Thus, a user may then cause an image to run in various directions, or to fly. A “jump” mode or “fight” mode are other examples of such potential mode transitions.

Another opportunity with respect to video games and other simulated environments is use of the center push signals to enter more sophisticated modes. A “fight” mode, for example, might involve allowing a simple pointing device signal to generate a complex command, such as bowing or kicking with a spiral jump, for example. Such commands can be executed as complex scripts triggered by simple pointing device commands when an appropriate mode is entered.

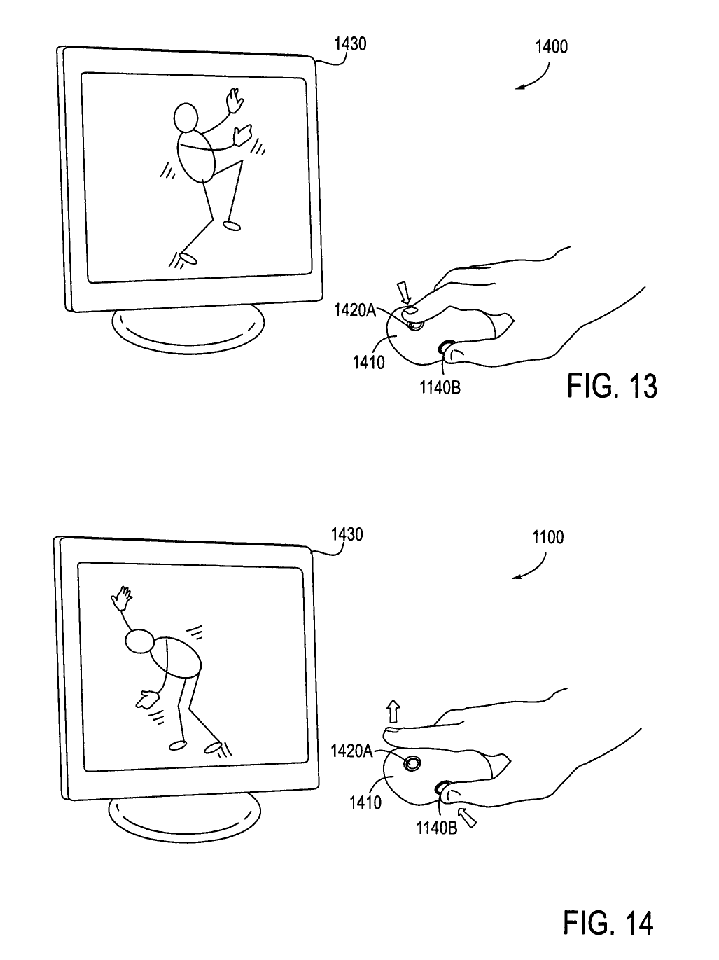

This may be illustrated with reference to FIGS. 13 and 14, for example. FIG. 13 further illustrates operation of an embodiment of a pointing device with additional degrees of freedom. The system of FIG. 13 includes system 1400, a monitor 1430, a pointing device chassis 1410 and center push buttons 1420A and 1420B. As illustrated, an image on monitor 1430 is walking or dancing in FIG. 13. FIG. 14 also illustrates operation of an embodiment of a pointing device with additional degrees of freedom. As illustrated, in FIG. 14, a control mode is triggered causing the image to take a bow. This may be done through use of a different control mode, or activation of a complex script through a simple pointing device signal in an appropriate control mode.

In one embodiment, a user may use a first mode for simple commands (e.g. move forward). The user may then create scripts of complex commands which can be assigned to specific commands in other modes. With three center push buttons, a user has twelve contact signals in each mode to work with, allowing for modes 2-8 to be assigned to up to 84 unique scripts, each associated with a separate contact signal.

While this discussion has centered primarily around video games, one will understand that it may relate to other simulated environments. Thus, use of these commands in a real-time remote control environment or an interactive environment would be possible. An interactive environment such as that provided by the Second Life networking system (available at www.secondlife.com) with an avatar that one may control may thus be amenable to such a system.

One may also use the various modes in CAD or animation software, allowing for control of different objects or types of motion during design of objects or design of animation sequences. The various modes can be assigned to different types of actions or to actions of different objects, for example. Likewise, customization of modes by users may be useful in such instances. Similarly, one can implement control of mapping software (such as fly over software available from Google Earth, for example), using these modes. Moreover, a reset mode or sequence of center push signals may also be implemented to allow one to undo or rewind a sequence of actions.

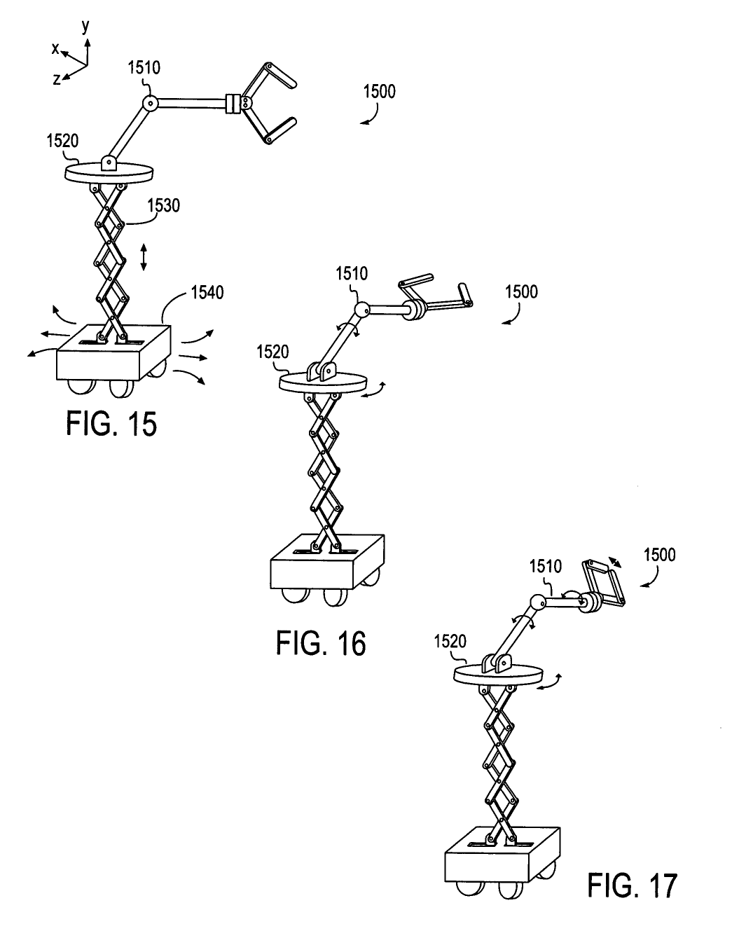

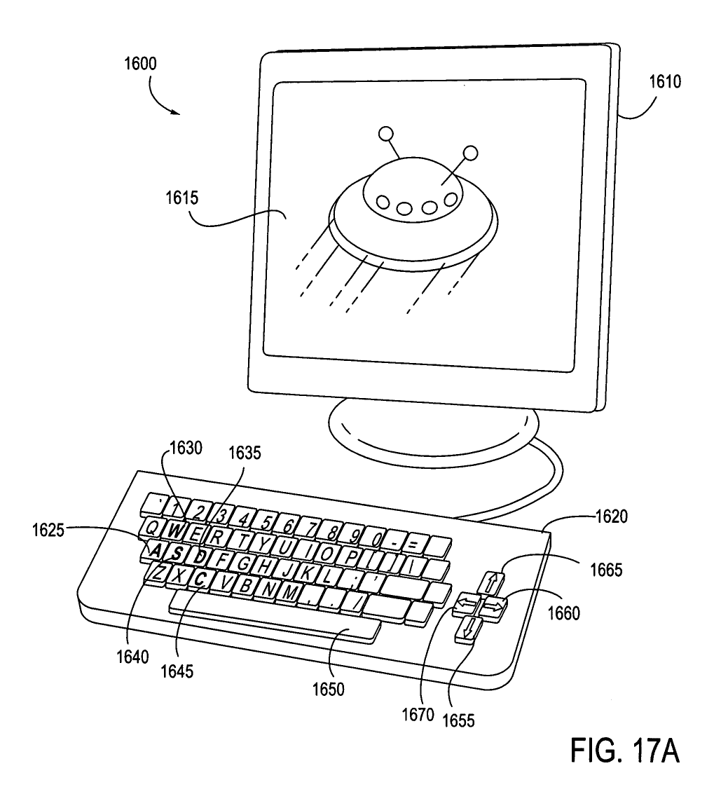

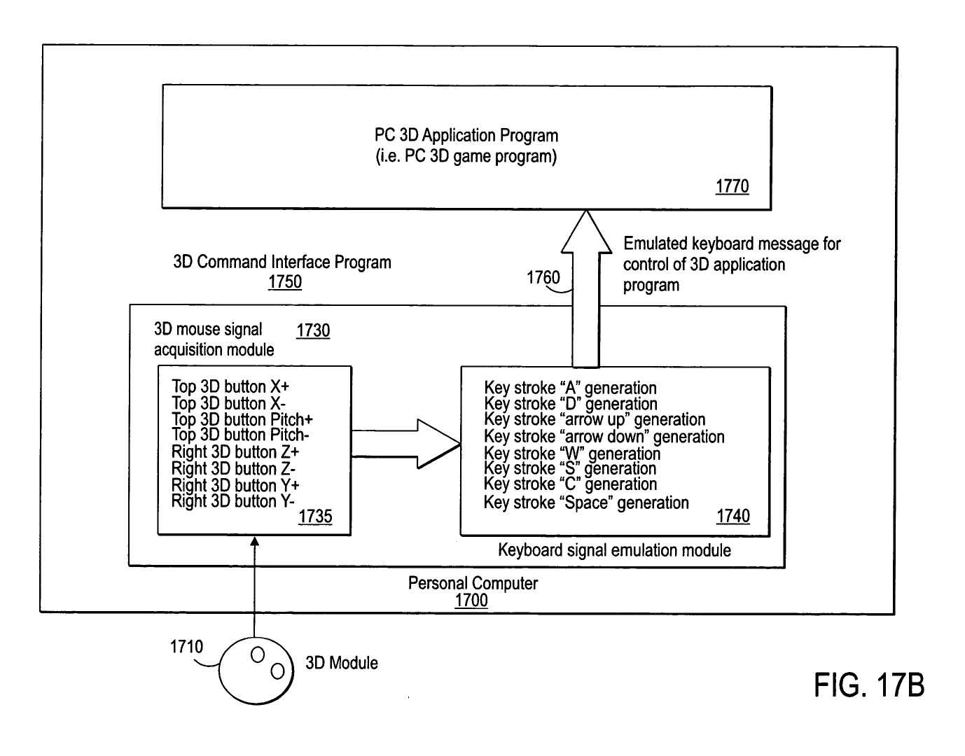

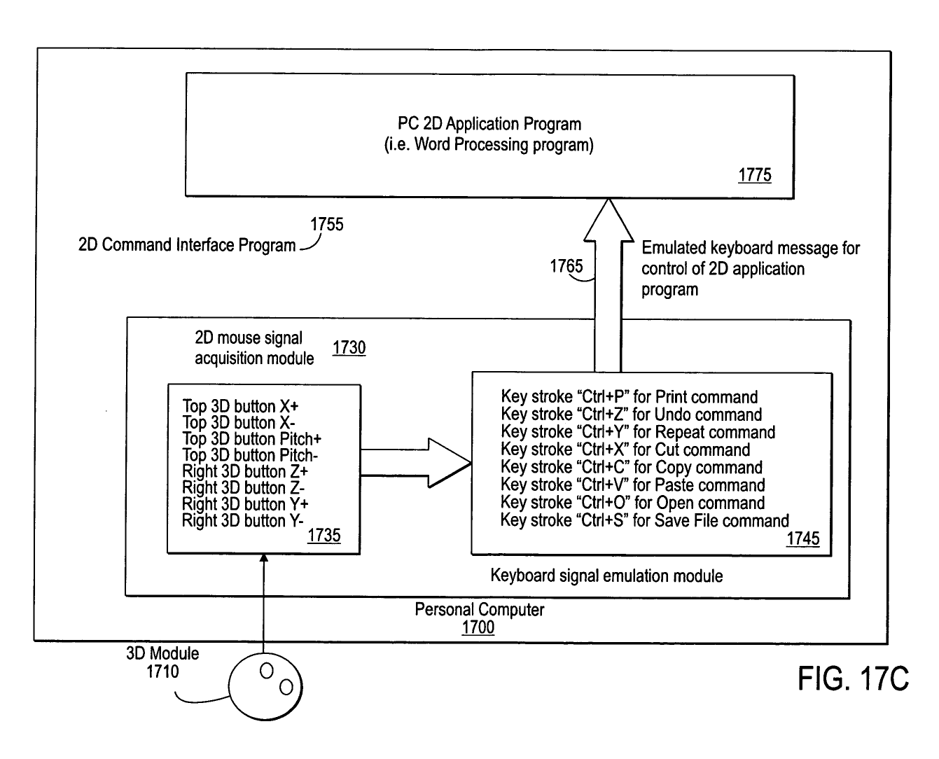

One may also control a robot (as discussed previously with respect to remote control), with various modes representing different types of action or motion of different parts of a robot. While a single object has six degrees of freedom in space, a linkage of objects may have many more degrees of freedom, requiring much more control of various component objects. FIG. 15 illustrates a device which may be controlled with an embodiment of a pointing device with additional degrees of freedom. FIGS. 16 and 17 further illustrate the device if FIG. 15. As illustrated in FIG. 15, a robot 1500 has a variety of separately movable parts, including a base 1540, an elevator 1530, an upper base 1520 and a movable arm 1510. The robot may be further understood to include such individually movable parts as the base, upper base, elevator, lower and upper arms and a gripper, for example. In one mode, the base 1540 and the elevator 1530 may be controlled, allowing the robot to be positioned vertically and laterally. In a second mode, the upper base 1520 may be controlled, along with the lower arm of arm 1510. In a third mode, the upper arm and gripper of arm 1510 may be controlled.

In one embodiment, in a first mode, the top button controls right and left rotation, and the right and left buttons control forward/backward motion and up/down motion. In a second mode, the top button controls pitch control of the arm, and the right and left buttons control yaw motion (about the Y axis) of the upper base. In a third mode, the top button controls pitch and roll motion of the arm, and the right and left buttons control forward/backward motion and open/close action of the gripper.

While control of 3D operation is one application of the pointing devices described herein, other software applications can be controlled with different modes, allowing for many commands operable based only on a pointing device. For example, one may assign commands from a program, such as cut, copy and paste, to various mode/contact selections. Similarly, while scripts of three dimensional action in animation or CAD can be useful, scripts recorded when using other types of software can also be assigned to pointing device signals. Thus, the degrees of freedom of motion can be adapted to other programs, such as those used for word processing or other data processing, for example.

FIG. 17A illustrates another embodiment of a system including a pointing device. In the system 1600 in question, keyboard commands are used to cause movement of an image 1615 (such as in a video game). The keyboard commands illustrated include move forward (1630), move backward (1640), move up (1645), move down (1650), move left (1625), move right (1635), pitch positive (1665) and negative (1655) and yaw positive (1670) and negative (1660). Each such command is controlled by a key of keyboard 1620. These commands in turn cause the image 1615 on monitor 1610 to react. One may control all of these commands with a pointing device with various levels of degrees of freedom, either alone or in concert with the keyboard.

In the case of a three dimensional application program (e.g. a CAD program or a game), emulation of 3D keyboard commands originating from a pointing device may make the system simpler for use with legacy 3D application programs. FIG. 17B illustrates a system wherein operation of a pointing device emulates operation of controls on a keyboard for a 3D application. System 1700 includes 3D pointing device 1710 coupled to a 3D pointing device data acquisition module 1730. Module 1735 receives data from pointing device 1710 (shown here as a mouse). Module 1730 then translates this data into keyboard signals 1760 using keyboard signal emulation module 1740.

All of this provides data out of a 3D command interface module 1750 which couples to a 3D application program 1770. Thus, application program 1770 receives expected signals (e.g. keyboard commands), even though a pointing device with various degrees of freedom is used. One need not reprogram application program 1770 in order to work with pointing device 1710—the emulation and data acquisition modules take care of the interface. However, from the point of view of the user, the pointing device with center-push buttons has an intuitive feel—pushing a button with an up-direction on a center-push button can cause an image to move up or rotate up, for example.

One may similarly emulate keyboard commands for more traditional application programs using a pointing device with multiple degrees of freedom. FIG. 17C illustrates a system wherein operation of a pointing device emulates operation of controls on a keyboard for a 2D application. By using a different keyboard signal emulation module 1745, commands such as Print (Ctrl-P) or Undo (Ctrl-Z) can be emulated using directional controls from the center-push buttons of a pointing device. In such an instance, the intuitive feel of a 3D program is not necessarily available. However, a user can operate many familiar commands with the pointing device, rather than by hunting around a keyboard for shortcut keys.

As one may appreciate, keeping track of what mode someone is operating in can be difficult. A system necessarily must keep track. However, it may be useful to provide feedback to a user on this point as well.

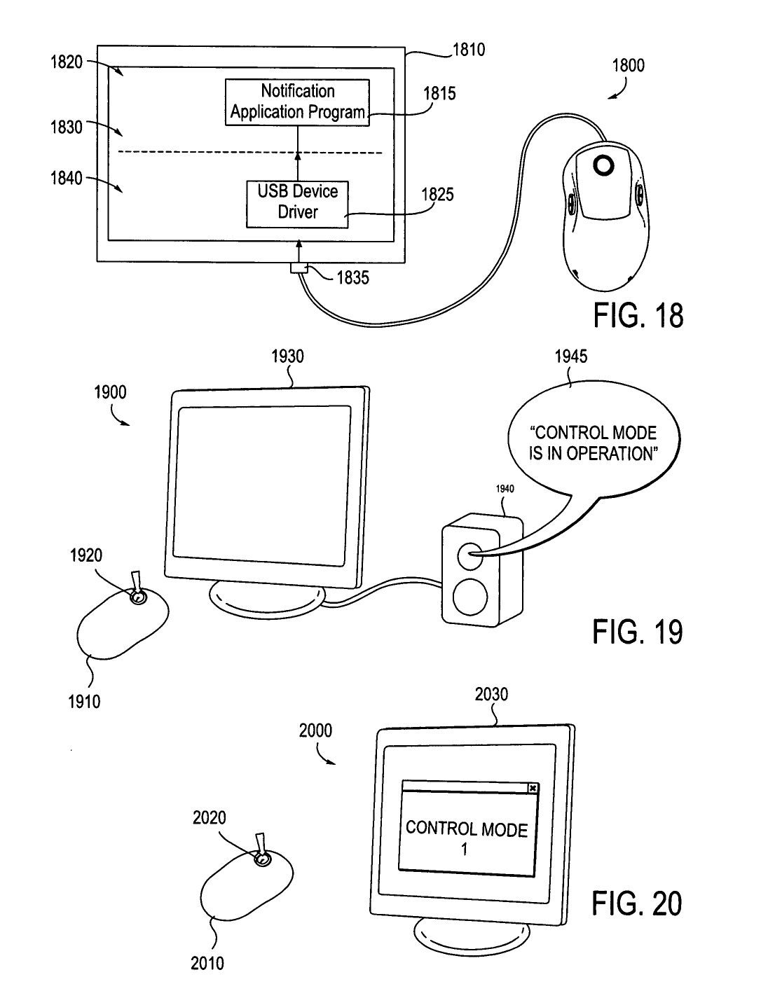

FIG. 18 illustrates a system which may work with an embodiment of a pointing device with additional degrees of freedom. With reference to an implementation using the Windows operating system, FIG. 18 provides an example of how a mouse or pointing device may interact with the operating system at various different resolutions. A system 1800 includes a personal computer 1810 which operates an operating system 1820 and interacts with a pointing device 1850. OS 1820 includes a user application layer 1830 and a kernel (or device) layer 1840. USB device driver 1825 communicates with USB mouse 1850 at a low level, interpreting signals received through USB connection 1835 (potentially after conversion at a physical level). Notification application program 1815 communicates with USB device driver 1825, receiving data originating from pointing device 1850, and relaying that data to other software or other parts of the system.

FIG. 19 illustrates another system which may work with an embodiment of a pointing device with additional degrees of freedom. System 1900 includes a pointing device 1910 with a center push button 1920, monitor 1930 and speaker 1940 (along with other components not shown). With the data acquired from a pointing device 1910, a processing module may be expected to generate user sound effects and/or trigger a change in an image on a monitor 1930. Generation of user sound effects can be implemented by requesting that a sound module play a sound wave file, either one predetermined overall by the system or a wave file selected by a user through a control panel of Windows or a similar control and preferences interface. Well known functions such as sndPlaySound( ) or PlaySound( ) may be used in this context. A voice sound 1945 may be generated, thereby alerting a user that “control mode 1” is in operation, for example. In a video game, a sound effect with background thunder could announce “fight mode” as another example.

As mentioned, a video/visual alert may also be desirable. FIG. 20 illustrates still another system which may work with an embodiment of a pointing device with additional degrees of freedom. System 2000 includes a pointing device 2010 with a center push button 2020, monitor 2030 and speaker 2040 (along with other components not shown). With the data acquired from a pointing device 2010, a processing module may send a message to the monitor 2030, triggering use of a predetermined bitmap or other icon image, for example. The Windows API SendMessage( ) may be used with pointing device data, for example, to trigger the change at the monitor 2030. Icons or other images can be registered or loaded in standard ways known for use with Windows, for example.

One skilled in the art will appreciate that although specific examples and embodiments of the system and methods have been described for purposes of illustration, various modifications can be made without deviating from the present invention. For example, embodiments of the present invention may be applied to many different types of software and operating systems or different types of computers. Moreover, features of one embodiment may be incorporated into other embodiments, even where those features are not described together in a single embodiment within the present document.

What is claimed is:

1. A pointing device, comprising:
a chassis;
a motion tracking mechanism mounted in the chassis;
a communications interface for coupling with a system;
a signal interface between the motion tracking mechanism and the communications interface, the signal interface carrying signals from the motion tracking mechanism to the communications interface; and
consisting of a single center push button, the center push button coupled to the signal interface and mounted on the chassis.

2. The pointing device of claim 1, wherein:
the pointing device is a mouse.

3. The pointing device of claim 1, wherein:
the pointing device is a trackball.

4. The pointing device of claims 1 and 2, further comprising:
A left mouse button; And
A right mouse button.

5. The pointing device of claim 4, further comprising:
A mouse wheel.

6. The pointing device of claims 1 and 3, further comprising:
A first left mouse button; And
A first right mouse button.

7. The pointing device of claim 6, further comprising:
A second left mouse button; And
A second right mouse button.

8. A system, comprising:
a host computer;
an operating system executed by the host computer;
a device driver included in the operating system;
a keyboard emulation module included in the device driver;
a pointing device coupled to the host computer, the pointing device having at least one center push button;
wherein:
the pointing device communicates with the device driver and provides signals from the at least one center push button to the device driver;
and wherein:
the keyboard emulation module of the device driver is to provide keyboard command outputs corresponding to the signals from the at least one center push button.

9. The system of claim 8, wherein:
The at least one center push button consists of a single center push button.

10. The system of claim 8, wherein:
The at least one center push button consists of two center push buttons.

11. The system of claim 10, wherein:
The center push buttons are mounted on a chassis of the pointing device in a top and a right position.

12. The system of claim 10, wherein:
The center push buttons are mounted on a chassis of the pointing device in a top and a left position.

13. The system of claim 10, wherein:
The center push buttons are mounted on a chassis of the pointing device in a left and a right position.

14. The system of claim 8, wherein:
The at least one center push button consists of three center push buttons.

15. The system of claim 9, wherein:
The center push button is mounted on a chassis of the pointing device in a left position.

16. The system of claim 9, wherein:
The center push button is mounted on a chassis of the pointing device in a right position.

17. The system of claim 9, wherein:
The center push button is mounted on a chassis of the pointing device in a top position.

18. The system of claim 9, wherein:
The system further comprises a speaker and a processing module to generate sounds for the speaker; and wherein:
The processing module is to generate sounds with the speaker corresponding to modes of the pointing device responsive to signals from the at least one center push button.

19. The system of claim 18, wherein:
The sounds include sound effects.

20. The system of claim 18, wherein:
The sounds include spoken words.

21. The system of claim 18, wherein:
The system includes a video monitor and the system is further to provide a video image change on the video monitor corresponding to modes of the pointing device responsive to signals from the at least one center push button.

22. A pointing device, comprising:
a chassis;
a motion tracking mechanism mounted in the chassis;
a communications interface for coupling with a system;
a signal interface between the motion tracking mechanism and the communications interface, the signal interface carrying signals from the motion tracking mechanism to the communications interface; and
consisting of two center push buttons, the center push buttons coupled to the signal interface and mounted on the chassis.

23. The pointing device of claim 22, wherein:
the pointing device is a mouse.

24. The pointing device of claim 22, wherein:
the pointing device is a trackball.

25. A pointing device, comprising:
a chassis;
a motion tracking mechanism mounted in the chassis;
a communications interface for coupling with a system;
a signal interface between the motion tracking mechanism and the communications interface, the signal interface carrying signals from the motion tracking mechanism to the communications interface; and
consisting of at least one center push button, the at least one center push button coupled to the signal interface and mounted on the chassis.

26. The pointing device of claim 25, wherein:
The at least one center push button is one center push button.

27. The pointing device of claim 26, wherein:
The center push button is mounted on the chassis of the pointing device in a left position.

28. The pointing device of claim 26, wherein:
The center push button is mounted on the chassis of the pointing device in a right position.

29. The pointing device of claim 26, wherein:
The center push button is mounted on the chassis of the pointing device in a top position.

30. The pointing device of claim 25, wherein:
The at least one center push button consists of two center push buttons.

31. The pointing device of claim 30, wherein:
The center push buttons are mounted on the chassis of the pointing device in a top and a right position.

32. The pointing device of claim 31, wherein:
The center push buttons are mounted on the chassis of the pointing device in a top and a left position.

33. The pointing device of claim 30, wherein:
The center push buttons are mounted on the chassis of the pointing device in a left and a right position.

34. The pointing device of claim 25, further comprising:
Means for tracking motion of the pointing device along a surface.

35. The pointing device of claim 34, wherein:
The means for tracking is an optical tracking mechanism.

36. The pointing device of claim 34, wherein:
The means for tracking is a mechanical tracking mechanism.
